(19) United States
(12) Patent Application Publication
(10) Pub. No.: US 2010/0124525 A1
(43) Pub. Date: May 20, 2010

(54) ZERO-HEAT-BURDEN FLUIDIZED BED REACTOR FOR HYDRO-CHLORINATION OF SiCl4 and M.G.-Si

(76) Inventor: Kuyen Li, Beaumont, TX (US)

Correspondence Address: TAYLOR & AUST, P.C., P.O. Box 560, 142. S Main Street, Avilla, IN, 46710, US

(21) Appl. No.: 12/619,988

(22) Filed: Nov. 17, 2009

Related U.S. Application Data
(60) Provisional application No. 61/115,949, filed on Nov. 19, 2008.

(51) Int. Cl. C01B 33/107; B01J 8/24; G05D 7/00

(52) U.S. Cl. 423/342; 422/145; 422/111

(57) ABSTRACT

The present invention is a process of producing chlorosilanes from a reaction of silicon tetrachloride in the presence of metallurgical grade silicon in a fluidized bed reactor, such that the fluidized bed reactor does not have an internal heat exchanger.

### CROSS REFERENCE TO RELATED APPLICATIONS

This is a non-provisional application based upon U.S. provisional patent application Ser. No. 61/115,949, entitled “Zero-Heat-Burden Fluidized Bed Reactor for Hydro-Chlorination of SiCl₄ and M.G.-Si,” filed Nov. 19, 2008, which is incorporated herein by reference.

### MICROFICHE APPENDIX

Not applicable.

### GOVERNMENT RIGHTS IN PATENT

Not applicable.

### BACKGROUND OF THE INVENTION

1. Field of the Invention

The present invention relates to processes for preparing chlorosilanes, and, more particularly, to a process for producing chlorosilanes from hydro-chlorination of silicon tetrachloride (SiCl₄) and metallurgical grade silicon (M.G.-Si) in a fluidized bed reactor without an introduction of heat.

2. Description of the Related Art

The present invention relates to the field of preparing chlorosilanes, such as, trichlorosilane (HSiCl₃), dichlorosilane (H₂SiCl₂), monochlorosilane (H₃SiCl), or a combination thereof, for use in multiple industries.

Chlorosilanes are valuable in the fields of electronics and adhesives. For example, HSiCl₃, especially the high purity grade, is used in the electronics industry including, for example, use in the preparation of solar and electronics grade polycrystalline silicon, which produces silicon tetrachloride as a by-product.

The process of preparing high purity HSiCl₃ is known from many patents, including, for example, U.S. Pat. Nos. 4,112,057; 3,540,861; and 3,252,752.

Prior art for the disportionation reactions of chlorosilanes typically utilize HSiCl₃ as a key starting reactant in the presence of a catalyst to produce H₂SiCl₂, H₃SiCl, and/or silane, SiH₄. Many different types and preferred catalysts for performing such chlorosilane disportionation reactions are known in the prior art.

U.S. Pat. No. 3,928,542 demonstrates an advantage of pretreating a catalyst material with hydrogen chloride for the disportionation reaction of HSiCl₃ to produce H₂SiCl₂, H₃SiCl, and silane. The catalyst material is in the form of anion exchange resin.

It is known to those of ordinary skill in the art that chlorosilanes are usually produced in a fluidized bed. For example, in DE 41 04 422 A1 it is taught that silicon may be reacted with hydrogen chloride, or silicon tetrachloride may be reacted with hydrogen in a fluidized bed without using pressure in the presence of copper salts of a low, aliphatic, saturated dicarbon acid, particularly copper oxalate.

A hydrogenation reaction of SiCl₄ and M.G.-Si is an endothermic reaction, and the associated reaction temperature for reaction is on the order of 500° C., which is considered to be relatively high. Typically, in order to input heat into the reaction in a fluidized bed reactor, an internal heat exchanger is used. However, such internal heat exchangers are known to possess severe erosion problems and require additional costs in energy, maintenance, and space.

What is needed in the art is a method for producing chlorosilanes from a hydrogenation reaction of SiCl₄ and M.G.-Si without needing to supply heat to the reaction.

### SUMMARY OF THE INVENTION

Exemplary embodiments of the present invention provide a process for producing chlorosilanes. The process is comprised of the steps of: introducing silicon tetrachloride (SiCl₄), metallurgical grade silicon (M.G.-Si), and hydrogen (H₂) to a fluidized bed reactor; and flowing anhydrous hydrogen chloride (HCl) into the fluidized bed reactor such that a temperature of a reaction associated with the HCl flowing into the fluidized bed reactor produces enough heat to drive a reaction of SiCl₄ and M.G.-Si to create chlorosilanes. There is no internal heat exchanger in the fluidized bed reactor.

The various exemplary embodiments herein further include a fluidized bed reactor for producing chlorosilanes from silicon tetrachloride (SiCl₄) and metallurgical grade silicon (M.G.-Si). The fluidized bed reactor is comprised of a SiCl₄ feed line; a M.G.-Si feed line; a hydrogen (H₂) feed line; an anhydrous hydrogen chloride (HCl) feed line; a thermal sensor; and an electronic controller. The thermal sensor is located within the fluidized bed reactor and communicates with the electronic controller to compare an actual temperature with a set-point temperature.

Other features and advantages of the invention will become apparent to those skilled in the art upon review of the following detailed description, claims and drawing.

### BRIEF DESCRIPTION OF THE DRAWING

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 is a schematic flow and control diagram of an exemplary embodiment of the present invention in a fluidized bed reactor.

### DETAILED DESCRIPTION OF THE INVENTION

Before the embodiments of the invention are explained in detail, it is to be understood that the invention is not limited in its application to the details of construction and the arrangements of the components set forth in the following description or illustrated in the drawing. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

A hydrogenation reaction of SiCl₄ and M.G.-Si is an endothermic reaction, and the associated reaction temperature for reaction is on the order of 500° C. As set forth above, when processing such reaction in a fluidized bed reactor, an internal heat exchanger often used in order to provide enough heat to drive the reaction. Such internal heat exchangers are well known to fail or not work adequately due to erosion.

In exemplary embodiments of the present invention, hydrogen chloride, HCl, is introduced to the reaction. A reaction of HCl and M.G.-Si is highly exothermic, and the heat released from such reaction may be directed to preheat the fluidized bed reactor during the startup/initiation of the reactor and cause the desired endothermic reaction between SiCl₄ and M.G.-Si in the presence of hydrogen (H₂).

The HCl fed into the fluidized bed reactor may be input via a stream, the flow rate of which may be adjusted as needed. For example, a particular flow rate of HCl into the fluidized bed reactor will allow the proper amount of HCl to react with M.G.-Si such that the heat expelled from the reaction is just around 500° C., the amount needed for the reaction of SiCl₄ and M.G.-Si.

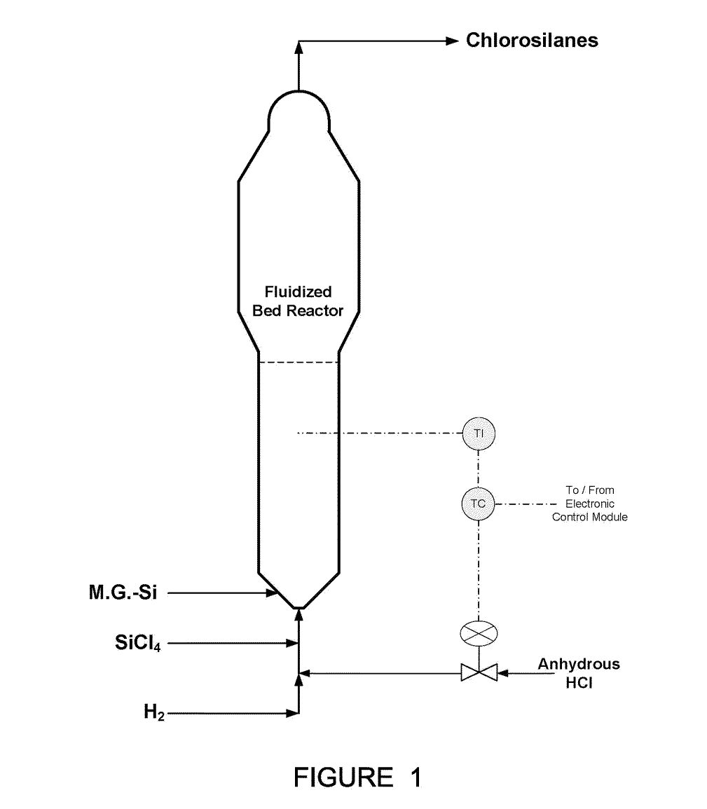

As illustrated in FIG. 1, streams of each of M.G.-Si, SiCl₄, H₂, and HCl may be fed into a fluidized bed reactor. A thermal sensor (not shown) may be positioned within the fluidized bed. Preferably, such thermal sensor is about two-thirds of a height of the fluidized bed reactor and about one-fourth of a diameter of the fluidized bed reactor. Such positioning of the thermal sensor allows, on the whole, the best representative of the true temperature of the fluidized bed reactor.

The thermal sensor may send a temperature signal (TI) back to a temperature controller (TC) to compare with a set-point temperature. An electronic controller (not shown) controls the flow rate of the HCl based on the difference (or lack thereof) between the set-point temperature and actual measured temperature as determined by the thermal sensor.

In exemplary embodiments, the electronic controller is a proportional-integral-differential (PID) controller and it uses a reverse controller action. That is, the controller opens an associated HCl valve to a greater extent when the measured temperature is less than the set-point temperature. The actual flow rate of the HCl into the fluidized bed reactor to attain the desired reaction temperature varies based on exterior temperature, container, pipes, etc.

Because the presently claimed invention does not require the use of an internal heat exchanger, capital input, operational costs, and maintenance costs are kept to a minimum when producing chlorosilanes from a hydro-chlorination of SiCl₄ and M.G.-Si in a fluidized bed.

It has also been found that more stable quality of chlorosilanes are produced using the presently claimed method as well.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A process for producing chlorosilanes, the process being comprised of the steps of:
introducing silicon tetrachloride (SiCl₄), metallurgical grade silicon (M.G.-Si), and hydrogen (H₂) to a fluidized bed reactor; and
flowing anhydrous hydrogen chloride (HCl) into the fluidized bed reactor such that a temperature of a reaction associated with the HCl flowing into the fluidized bed reactor produces enough heat to drive a reaction of SiCl₄ and M.G.-Si to create chlorosilanes; wherein there is no internal heat exchanger in the fluidized bed reactor.

2. The process according to claim 1, wherein the temperature of the reaction associated with the HCl flowing into the fluidized bed reactor is about 500° C.

3. The process according to claim 1, wherein a thermal sensor is located within the fluidized bed reactor and communicates with an electronic controller to compare an actual temperature with a set-point temperature.

4. The process according to claim 3, wherein the thermal sensor is about two-thirds of a height of the fluidized bed reactor and about one-fourth of a diameter of the fluidized bed reactor.

5. The process according to claim 3, wherein the electronic controller controls the flow rate of the HCl based on the difference or lack thereof between the set-point temperature and actual temperature as determined by the thermal sensor.

6. The process according to claim 3, the electronic controller is a proportional-integral-differential (PID) controller and it uses a reverse controller action.

7. A fluidized bed reactor for producing chlorosilanes from silicon tetrachloride (SiCl₄), metallurgical grade silicon (M.G.-Si), the fluidized bed reactor being comprised of:
a SiCl₄ feed line;
a M.G.-Si feed line;
a hydrogen (H₂) feed line;
a hydrogen chloride (HCl) feed line;
a thermal sensor; and
an electronic controller;
such that the thermal sensor is located within the fluidized bed reactor and communicates with the electronic controller to compare an actual temperature with a set-point temperature.

8. The fluidized bed reactor according to claim 7, wherein the temperature of the reaction associated with the HCl flowing into the fluidized bed reactor is about 500° C.

9. The fluidized bed reactor according to claim 7, wherein the thermal sensor is about two-thirds of a height of the fluidized bed reactor and about one-fourth of a diameter of the fluidized bed reactor.

10. The fluidized bed reactor according to claim 7, wherein the electronic controller controls the flow rate of the HCl based on the difference or lack thereof between the set-point temperature and actual temperature as determined by the thermal sensor.

11. The fluidized bed reactor according to claim 7, the electronic controller is a proportional-integral-differential (PID) controller and it uses a reverse controller action.

12. The fluidized bed reactor according to claim 7, where there is not an internal heat exchanger.
